(19) United States
(12) Patent Application Publication
(10) Pub. No.: US 2025/0272125 A1
(43) Pub. Date: Aug. 28, 2025

(54) METHOD, DEVICE, SYSTEM, AND COMPUTER PROGRAM FOR DISTRIBUTING KUBERNETES APPLICATION

(71) Applicant: SAMSUNG SDS CO., LTD., Seoul (KR)

(72) Inventors: Dongmoon Kim, Seoul (KR); Duckhwan Kim, Seoul (KR); Yongchol Shin, Seoul (KR)

(73) Assignee: SAMSUNG SDS CO., LTD., Seoul (KR)

(21) Appl. No.: 19/062,995

(22) Filed: Feb. 25, 2025

(30) Foreign Application Priority Data
Feb. 26, 2024 (KR) 10-2024-0027219
Apr. 23, 2024 (KR) 10-2024-0053797

(51) Int. Cl. G06F 9/455; G06F 9/451

(52) U.S. Cl. CPC G06F 9/455; G06F 9/451; G06F 2009/4557

(57) ABSTRACT

The present disclosure relates to a method, a device, a system, and a computer program for distributing a Kubernetes application and, more specifically, the present disclosure provides a method for distributing a Kubernetes application by using a computing device, the method including configuring a distribution package file by reflecting screen configuration information for distribution option setup, obtained based on distribution information on a Kubernetes application, providing an option setup screen for the Kubernetes application, configured based on the distribution package file, and distributing the Kubernetes application by reflecting an option setting collected through the option setup screen.

### CROSS-REFERENCE TO RELATED APPLICATION(S)

This application is based on and claims priority under 35 U.S.C. 119 to Korean Patent Applications No. 10-2024-0027219, filed on Feb. 26, 2024 and No. 10-2024-0053797, filed on Apr. 23, 2024, in the Korean Intellectual Property Office, the disclosure of which is herein incorporated by reference in its entirety.

### BACKGROUND

### 1. Field

The present disclosure relates to a method, a device, a system, and a computer program for distributing a Kubernetes application and, more specifically, a method, a device, a system, and a computer program for distributing a Kubernetes application, by which a Kubernetes application may be distributed according to an option set through a screen provided based on screen configuration information for distribution option setup included in a Kubernetes application distribution package.

### 2. Description of the Prior Art

With the recent increase in various services based on online environments, cloud platforms are also rapidly expanding.

Furthermore, cloud platforms based on Kubernetes have been increasing recently, and Platform as a Service (PaaS), which provide various applications such as databases and search solutions based on Kubernetes, are also continuously growing.

In this regard, Kubernetes applications have conventionally been distributed by commonly using Helm, which is a package manager for distributing Kubernetes-based applications. However, when distribution options selectable by users are added or changed due to application updates, users had to directly perform a series of tasks to set a distribution option and apply same to receive an application distribution, leading to inconvenience.

Moreover, in distributing Kubernetes applications in conventional methods, it may be more difficult for non-experts with insufficient relevant knowledge to perform a process such as option setup for a Kubernetes application and distribution reflecting same. Therefore, this may result in delays in Kubernetes application distribution.

In this regard, it would be desirable to implement and provide an environment that allows users to conveniently perform a process such as option setup and distribution for Kubernetes applications. However, reflecting all various Kubernetes applications and option addition and change for each version to implement individually distribution environments requires a significant amount of human resources and time and thus involves difficult.

Accordingly, there is a demand for a method that enables users to more conveniently set options for distributing a Kubernetes application and efficiently distribute the Kubernetes application according to the set options. However, an appropriate solution has not yet been proposed.

### SUMMARY

The present disclosure has been made to solve the above problems of the conventional technologies and an aspect of the present disclosure is to provide a method, a device, a system, and a computer program for distributing a Kubernetes application, which enable a user to conveniently set an option for distribution of a Kubernetes application and, furthermore, efficiently distribute the Kubernetes application according to the set option.

In addition, an aspect of the present disclosure is to provide a method, a device, a system, and a computer program for distributing a Kubernetes application, which enable automatic configuration and provision of an environment in which a Kubernetes application is distributable by reflecting the addition, change, etc. of configurable options with respect to various Kubernetes applications.

The technical task to be achieved in the present disclosure is not limited to that mentioned above, and other technical tasks that are not mentioned above may be clearly understood to a person having common knowledge in the technical field to which the present disclosure belongs based on the content described in the present specification.

As a first aspect of the present disclosure, a method for distributing a Kubernetes application by using a computing device may include configuring a distribution package file by reflecting screen configuration information for distribution option setup, obtained based on distribution information on a Kubernetes application, providing an option setup screen for the Kubernetes application, configured based on the distribution package file, and distributing the Kubernetes application by reflecting an option setting collected through the option setup screen.

Here, the configuring may include collecting distribution information on the Kubernetes application.

In addition, the configuring may include obtaining distribution option setup information regarding an option required to be set for the Kubernetes application, based on the distribution information.

In addition, the configuring may include generating screen configuration information for distribution option setup for the Kubernetes application, based on distribution option setup information.

In the generating, the screen configuration information may be generated using a large language model, based on the distribution option setup information.

In the configuring, the screen configuration information generated from the large language model may be included in the distribution package file.

In addition, in the providing, an option setup screen provision unit operated in the computing device may collect the screen configuration information from the distribution package file to configure and provide the option setup screen.

In addition, in the distributing, a resource distributed for the Kubernetes application may be changed by reflecting the option setting.

As a second aspect of the present disclosure, in a device for distributing a Kubernetes application, the device including a processor and a memory, the memory may include instructions that are configured to, when executed by the processor, cause the device to implement particular operations, and the particular operations may include configuring a distribution package file by reflecting screen configuration information for distribution option setup, obtained based on distribution information on a Kubernetes application, providing an option setup screen for the Kubernetes application, configured based on the distribution package file, and distributing the Kubernetes application by reflecting an option setting collected through the option setup screen.

Here, in the configuring, distribution information on the Kubernetes application may be collected.

In addition, in the configuring, distribution option setup information regarding an option required to be set for the Kubernetes application may be obtained based on the distribution information.

In addition, in the configuring, screen configuration information for distribution option setup for the Kubernetes application may be generated based on distribution option setup information.

In the generating, the screen configuration information may be generated using a large language model, based on the distribution option setup information.

Furthermore, in the configuring, the screen configuration information generated from the large language model may be included in the distribution package file.

In addition, in the providing, an option setup screen provision unit operated in a computing device may collect the screen configuration information from the distribution package file to configure and provide the option setup screen.

In addition, in the distributing, a resource distributed for the Kubernetes application may be changed by reflecting the option setting.

In addition, as a third aspect of the present disclosure, in a computer-readable storage medium storing instructions configured to, when executed by a processor, cause a device, including the processor, for distributing a Kubernetes application to implement particular operations, the particular operations may include configuring a distribution package file by reflecting screen configuration information for distribution option setup, obtained based on distribution information on a Kubernetes application, providing an option setup screen for the Kubernetes application, configured based on the distribution package file, and distributing the Kubernetes application by reflecting an option setting collected through the option setup screen.

Here, in the configuring, distribution information on the Kubernetes application may be collected.

In addition, in the configuring, distribution option setup information regarding an option required to be set for the Kubernetes application may be obtained based on the distribution information.

In addition, in the configuring, screen configuration information for distribution option setup for the Kubernetes application may be generated based on distribution option setup information.

Accordingly, in a method, a device, a system, and a computer program for distributing a Kubernetes application according to an embodiment of the present disclosure, a user can conveniently set an option for distribution of a Kubernetes application and, furthermore, efficiently distribute the Kubernetes application according to the set option.

In addition, in a method, a device, a system, and a computer program for distributing a Kubernetes application according to an embodiment of the present disclosure, an environment in which a Kubernetes application is distributable by reflecting the addition, change, etc. of configurable options with respect to various Kubernetes applications can be automatically configured and provided.

Effects which are acquirable in the present disclosure are not limited to the effects described above, and other effects that have not been mentioned may be clearly understood by a person who has common knowledge in the technical field to which the present disclosure belongs, from the content described in the present specification.

### BRIEF DESCRIPTION OF THE DRAWINGS

The accompanying drawings, which are included as a part of the detailed description to help understanding of the present disclosure, provide embodiments of the present disclosure and are used to describe the technical spirit of the present disclosure together with the detailed description.

FIG. 1 is a diagram illustrating an example configuration of a system for distributing a Kubernetes application according to an embodiment of the present disclosure.

FIG. 2 is a flowchart illustrating an example of a method for distributing a Kubernetes application according to an embodiment of the present disclosure.

FIG. 3 is a diagram illustrating an example of a specific flowchart for configuring in a method for distributing a Kubernetes application according to an embodiment of the present disclosure.

FIG. 4 to FIG. 6 are diagrams illustrating a specific operation of an application distribution system according to an embodiment of the present disclosure.

FIG. 7, FIGS. 8A to 8C, 9A to 9C and 10A to 10C are diagrams illustrating an example of an option setup screen configuration in an application distribution system according to an embodiment of the present disclosure.

FIG. 11 illustrates an example of a block diagram of a device for distributing a Kubernetes application according to an embodiment of the present disclosure.

FIG. 12 is a diagram illustrating an example of a configuration of a computing device according to an embodiment of the present disclosure.

### DETAILED DESCRIPTION

Hereinafter, embodiments provided in the present specification will be described with reference to the accompanying drawings. The aspects, specific advantages, and novel features of the present disclosure will become more apparent from the detailed description and preferred embodiments below, which are associated with the accompanying drawings.

Prior to the above, the terms and words used in this specification and claims should be interpreted in a manner and a concept consistent with the technical spirit of the present disclosure, as the inventor has defined the concepts appropriately to describe the present disclosure in the best possible way. They are provided merely for the sake of describing the embodiments and should not be construed as limiting the present disclosure.

In assigning reference numerals to elements, the same reference numeral will be assigned to identical or similar elements regardless of reference numerals, and redundant descriptions thereof will be omitted. The suffixes “module” and “unit” of elements mentioned in the following description are given and used together for ease of specification writing, and thus do not have any distinguishable meanings or roles, and may indicate software or hardware elements.

In describing the elements of the present disclosure, when an element is expressed in the singular form, it should be understood to include the plural form as well, unless specifically stated otherwise. Furthermore, the terms “first”, “second”, and the like are used to distinguish one element from another and do not imply that the elements are limited by these terms. Additionally, when an element is connected to another element, it implies that another element may be connected between the element and the other element.

In addition, in describing the embodiments disclosed herein, a detailed description of known relevant technologies will be omitted when it may make the subject matter of the embodiment disclosed herein rather unclear. In addition, the accompanying drawings are merely intended to facilitate understanding of the embodiments disclosed herein and not to restrict the technical spirit disclosed herein. In addition, the accompanying drawings should be understood as covering all modifications, equivalents, or alternatives included in the spirit and scope of the present disclosure.

Hereinafter, illustrative embodiments of a method, a device, a system, and a computer program for distributing a Kubernetes application according to the present disclosure will be described in detail with reference to the accompanying drawings.

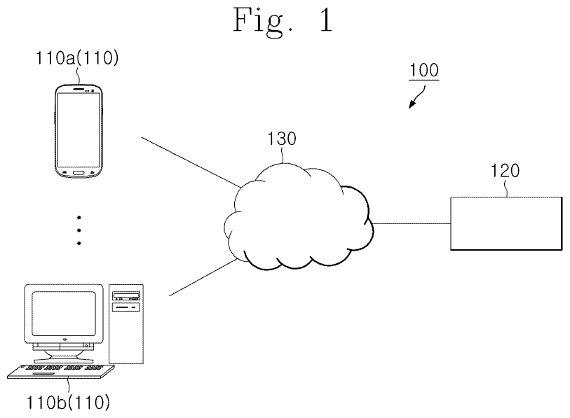

First, FIG. 1 illustrates an example of a configuration and an operation of a system 100 for distributing a Kubernetes application according to an embodiment of the present disclosure. As shown in FIG. 1, the system 100 for distributing a Kubernetes application according to an embodiment of the present disclosure may include one or more terminals 110a and 110b of a user, and a device 120 for distributing a Kubernetes application, which may distribute a Kubernetes application according to an option set for the user.

As the terminals 110a and 110b, various terminals capable of providing a Kubernetes application to a user, such as a personal computer (PC), a notebook PC, a tablet PC, a smartphone, a PDA, etc., may be used. However, the present disclosure is not necessarily limited thereto, and various other devices including a relay device capable of providing a pre-distributed Kubernetes application to a user in association with a device of the user, or providing information on a preset distribution option to the device 120 for distributing a Kubernetes application may be used as the terminals 110a and 110b.

In addition, the device 120 for distributing a Kubernetes application may be implemented as a system capable of distributing a Kubernetes application by using one or more physical server devices (servers). However, the present disclosure is not necessarily limited thereto, and it is also possible to configure the device by using a personal computing device, such as a desktop computer, a notebook, a tablet, a smartphone, etc., configure the device, based on a cloud system, or implement the device in various forms such as a dedicated device.

Furthermore, it is also possible to implement the terminals 110a and 110b and the device 120 for distributing a Kubernetes application to be coupled as one server.

In addition, as a network 130 connecting the terminals 110a and 110b and the device 120 for distributing a Kubernetes application, a wired network and a wireless network may be used and, specifically, various communication networks including a local area network (LAN), a metropolitan area network (MAN), and a wide area network (WAN) may be included. In addition, the network 130 may also include a known world wide web (WWW). Furthermore, the network 130 may also be implemented using a data bus configured to be able to transmit and receive data, etc.

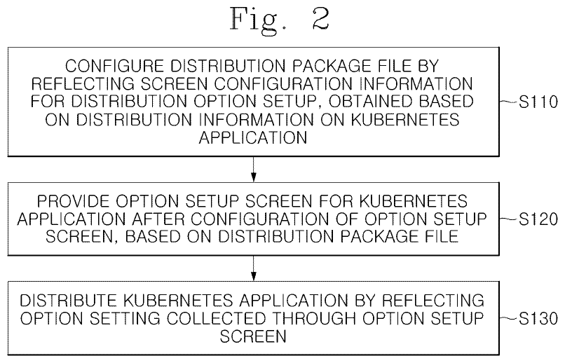

In addition, FIG. 2 illustrates an example of a flowchart of a method for distributing a Kubernetes application according to an embodiment of the present disclosure.

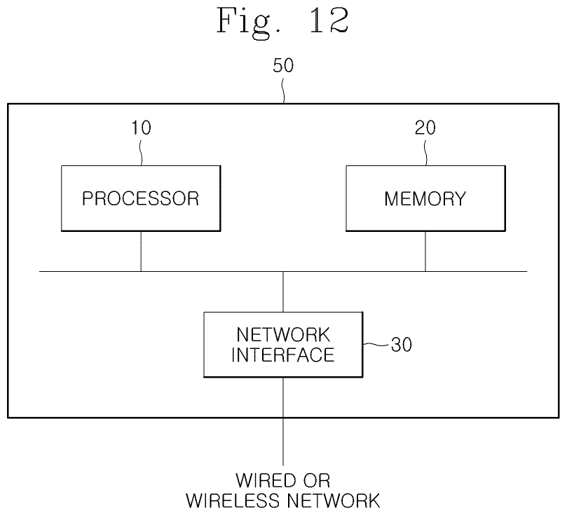

The method illustrated in FIG. 2 may be performed by, for example, the device 120 for distributing a Kubernetes application, and in addition, the device 120 for distributing a Kubernetes application may be implemented to include a computing device 50 in FIG. 12 and the description below related to FIG. 12. For example, the device 120 for distributing a Kubernetes application may include a processor 10 and the processor 10 may perform an instruction configured to implement an operation for distributing a Kubernetes application.

More specifically, as shown in FIG. 2, a method for distributing a Kubernetes application according to an embodiment of the present disclosure is a method for distributing a Kubernetes application by using the computing device 50 such as the device 120 for distributing a Kubernetes application and may include configuring a distribution package file by reflecting screen configuration information for distribution option setup, obtained based on distribution information on a Kubernetes application (S110), providing an option setup screen for the Kubernetes application, configured based on the distribution package file (S120), and distributing the Kubernetes application by reflecting an option setting collected through the option setup screen (S130).

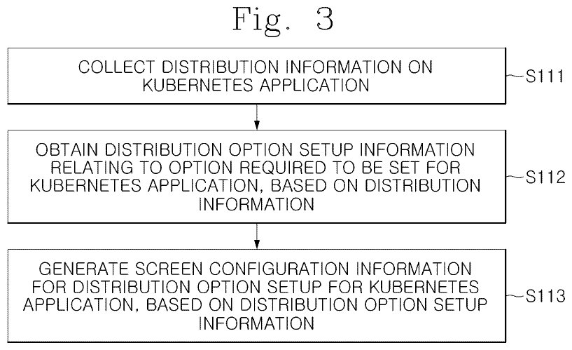

Here, the configuring (S110) may include collecting distribution information on the Kubernetes application (S111), as shown in FIG. 3.

In addition, the configuring (S110) may include obtaining distribution option setup information regarding an option required to be set for the Kubernetes application, based on the distribution information (S112), as shown in FIG. 3.

In addition, the configuring (S110) may include generating screen configuration information for distribution option setup for the Kubernetes application, based on distribution option setup information (S113), as shown in FIG. 3.

In the generating (S113) the screen configuration information may be generated using a large language model, based on the distribution option setup information.

Furthermore, in the configuring (S110), the screen configuration information generated from the large language model may be included in the distribution package file.

In addition, in the providing (S120), an option setup screen provision unit 122 operated in the computing device 50 may collect the screen configuration information from the distribution package file to configure and provide the option setup screen.

In addition, in the distributing (S130), a resource distributed for the Kubernetes application may be changed by reflecting the option setting.

Accordingly, in a method, a device, a system, and a computer program for distributing a Kubernetes application according to an embodiment of the present disclosure, a user can conveniently set an option for distribution of a Kubernetes application and, furthermore, efficiently distribute the Kubernetes application according to the set option, and in addition, an environment in which a Kubernetes application is distributable by reflecting the addition, change, etc. of configurable options with respect to various Kubernetes applications can be automatically configured and provided.

Hereinafter, a configuration and an operation of a method, a device, and the system 100 for distributing a Kubernetes application according to an embodiment of the present disclosure are described in more detail with reference to each drawing.

First, in operation S110, the computing device 50 such as the device 120 for distributing a Kubernetes application may configure a distribution package file by reflecting screen configuration information for distribution option setup, obtained based on distribution information on a Kubernetes application.

As shown in FIG. 3, the configuring (S110) may include one or more of collecting distribution information on the Kubernetes application (S111), obtaining distribution option setup information regarding an option required to be set for the Kubernetes application, based on the distribution information (S112), and generating screen configuration information for distribution option setup for the Kubernetes application, based on the distribution option setup information (S113).

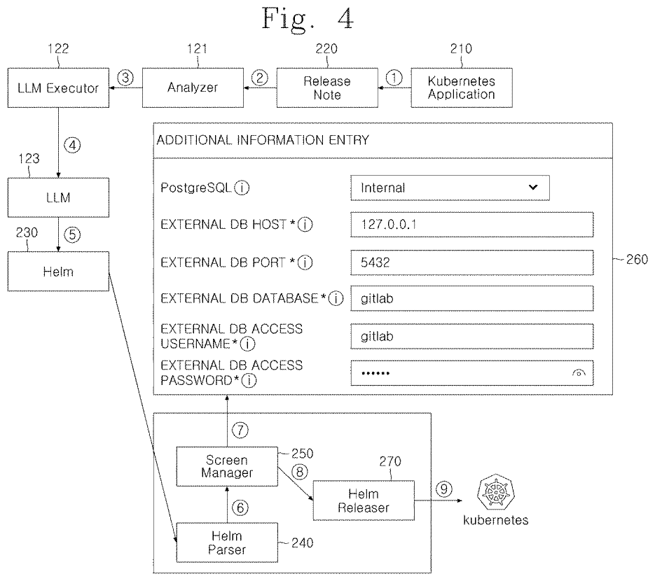

More specifically, as shown in FIG. 4, in operation S111, when the device 120 for distributing a Kubernetes application is to distribute a Kubernetes application 210, such as MongoDB or Elasticsearch that is a database application, the device 120 may collect distribution information 220 including various information related to distribution of each Kubernetes application, such as a release note or readme file for each Kubernetes application, a configuration according to a version or information on the addition, change, etc. of a distribution option such as a user manual for each Kubernetes application, and information on a usage method.

In this case, it is possible for the device 120 for distributing a Kubernetes application to collect distribution information in various methods, such as collecting distribution information on each Kubernetes application from a file included in a distribution package, perform website crawling, or receiving same from a user (\textcircled{1} in FIG. 4).

In addition, in operation S112, the device 120 for distributing a Kubernetes application may obtain distribution option setup information regarding an option required to be set for the Kubernetes application, based on the distribution information.

For example, while application A v1.0 has been distributed to use PostgresSQL as Internal, application A v2.0 may be configured to be distributable through selection of PostgresSQL as Internal or External.

In this case, the device 120 for distributing a Kubernetes application may analyze the distribution information 220, such as a release note of application A v2.0, to obtain distribution option setup information including information on an option settable by a user for application A v2.0, such as selection of Internal or External for PostgresSQL.

Accordingly, referring to FIG. 4, the device 120 for distributing a Kubernetes application may collect the distribution information 220, such as a release note of a Kubernetes application (\textcircled{2} in FIG. 4), and analyze same to obtain distribution option setup information regarding the Kubernetes application (reference numerical 221, \textcircled{3} in FIG. 4).

Next, in operation S113, the device 120 for distributing a Kubernetes application generates screen configuration information for distribution option setup for the Kubernetes application, based on the distribution option setup information.

In operation S113, the screen configuration information may be generated using a large language model, based on the distribution option setup information.

Furthermore, in operation S110, the screen configuration information generated from the large language model may be included in a distribution package file.

More specifically, as shown in FIG. 4, the device 120 for distributing a Kubernetes application may configure a prompt, etc., based on the distribution option setup information obtained by analyzing the distribution information 220 and input the prompt into a large language model (LLM) to operate the model to generate screen configuration information (reference numerical 222 and \textcircled{4} in FIG. 4).

Accordingly, a large language model (LLM) 223 may obtain screen configuration information for distribution option setup by being operated using, as an input, a prompt configured based on distribution option setup information \textcircled{5} in FIG. 4), and configure a distribution package file (reference numeral 230 in FIG. 4) for the Kubernetes application, such as Helm, etc., based on the screen configuration information.

In the present disclosure, the screen configuration information may be configured by being included in a file of values.yaml of Helm, but the present disclosure is not necessarily limited thereto, and the information may be implemented in various methods, such as configuring and storing a separate file.

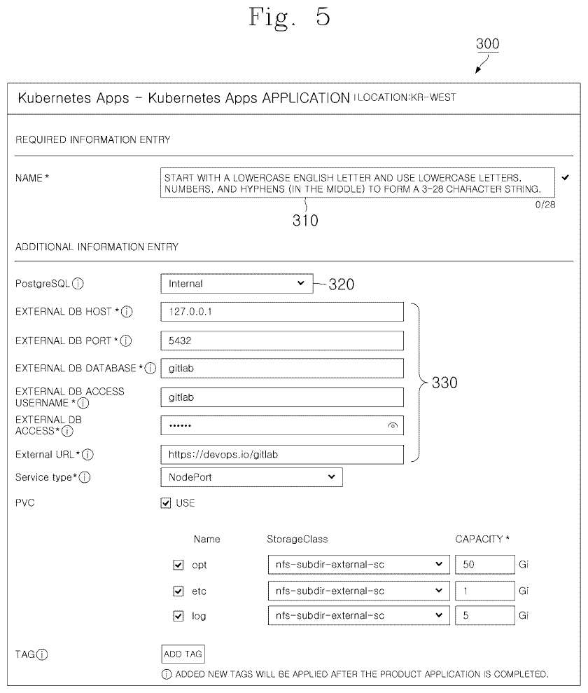

In a more specific example, as shown in FIG. 5, the device 120 for distributing a Kubernetes application may configure and provide an option setup screen by using screen configuration information generated based on distribution option setup information including selection of Internal or External for PostgresSQL with respect to the example of application A v2.0 as described above (reference numeral 300 in FIG. 5).

Accordingly, the user may input information required for distributing application A, such as selection of Internal or External for PostgresSQL, in an option setup screen provided through the terminals 110a and 110b, etc. (reference numerals 310 to 330 in FIG. 5), and the device 120 for distributing a Kubernetes application may change and apply a resource distributed for application A by reflecting the user's option setting.

In a more specific example, as shown in FIG. 4, the device 120 for distributing a Kubernetes application may analyze, through parsing, a distribution package file (reference numeral 230 in FIG. 4) for the Kubernetes application, such as a file of values.yaml of Helm (reference numeral 240 in FIG. 4) and transmit, to a screen manager (reference numeral 250 in FIG. 4), an analysis result (\textcircled{6} in FIG. 4) including screen configuration information obtained through the analysis so as to dynamically configure and provide an option setup screen (reference numeral 260 in FIG. 4) to the user.

Accordingly, the device 120 for distributing a Kubernetes application may distribute application A by reflecting information (\textcircled{8} in FIG. 4) such as an option setting input by the user (reference numeral 270 and \textcircled{9} in FIG. 4).

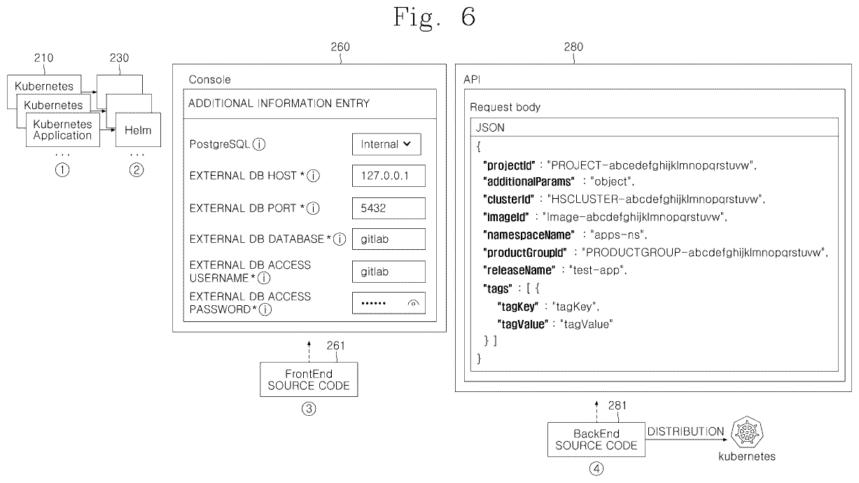

In addition, FIG. 6 illustrates a specific operation of a method for distributing a Kubernetes application according to an embodiment of the present disclosure.

As shown in FIG. 6, first, the device 120 for distributing a Kubernetes application may configure a distribution package file of a corresponding Kubernetes application, such as a file of values.yaml of Helm, by reflecting screen configuration information, based on distribution option setup information obtained by analyzing the distribution information 220 such as a release note with respect to each Kubernetes application (reference numeral 210 and \textcircled{1} in FIG. 6) (reference numeral 230 and \textcircled{2} in FIG. 6).

Next, the device 120 for distributing a Kubernetes application may dynamically configure and provide an option setup screen (reference numeral 260 in FIG. 6) to a user, based on the distribution package file and, accordingly, may automatically configure and provide an option setup screen enabling the user to set an option for a Kubernetes application without manually changing a frontend source code (reference numeral 261 and \textcircled{3} in FIG. 6).

In addition, in the present disclosure, the device 120 for distributing a Kubernetes application may reflect an option setting input by the user through an option setup screen to distribute a Kubernetes application and, accordingly, may automatically distribute a Kubernetes application by reflecting an option setting input by the user, such as changing a resource distributed for a Kubernetes application without the user manually changing a backend source code (reference numeral 281 and \textcircled{4} in FIG. 6) such as an application programming interface (API) (reference numeral 280 in FIG. 6)

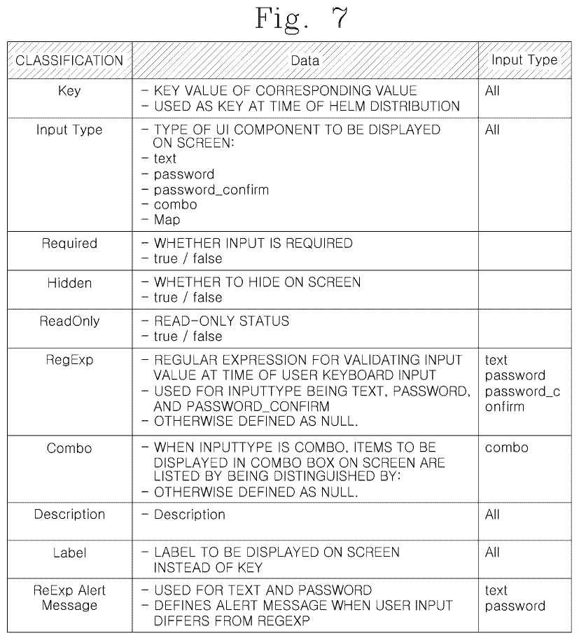

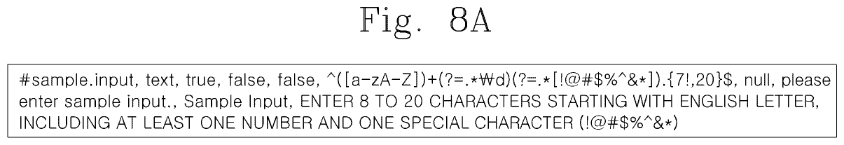

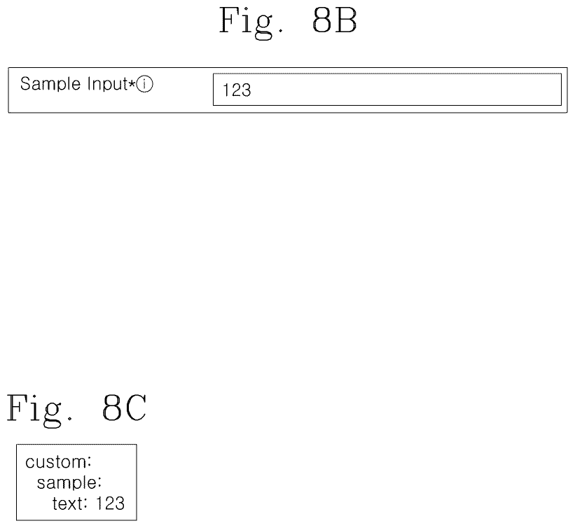

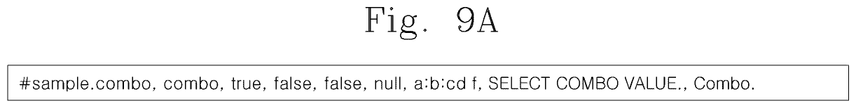

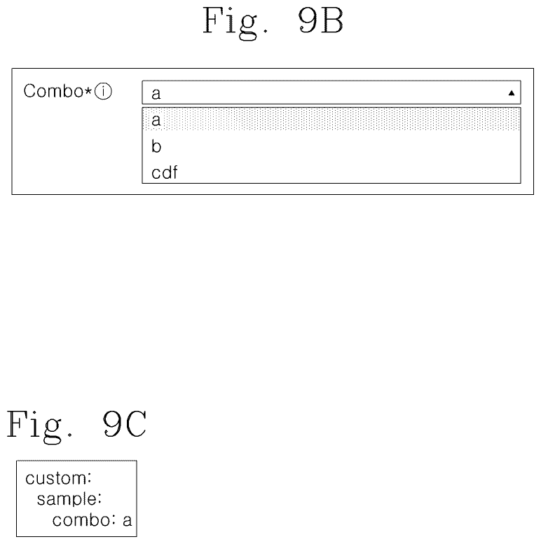

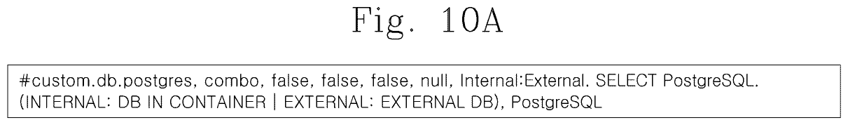

More specifically, FIG. 7 illustrates an example of a specification of screen configuration information which is definable in a distribution package file for a Kubernetes application, such as a file of values.yaml of Helm, in a method for distributing a Kubernetes application according to an embodiment of the present disclosure.

As shown in FIG. 7, in the present disclosure, a distribution package file for a Kubernetes application, such as a file of values.yaml of Helm, may include a key value (Key) for each value for configuring an option setup screen, a type (Input Type) of a UI component to be displayed on a screen, whether input is required (Required), etc., and furthermore, may include whether to hide on a screen (Hidden), a read-only status (ReadOnly), and a regular expression (RegExp) for validating an input value at the time of user input.

In addition, the file may also include items (Combo) to be output when defined as a combo box, description (Description), content (Label) to be displayed on a screen instead of a key, and a message (RegExP) to be displayed when a user's input differs from RegExp.

Accordingly, the device 120 for distributing a Kubernetes application may automatically configure and provide an option setup screen, based on the screen configuration information of FIG. 7 included in a distribution package file for a Kubernetes application, such as a file of values.yaml of Helm.

In a more specific example, FIGS. 8A to 8C illustrate examples of a case of displaying text in a distribution package file for a Kubernetes application.

In the present disclosure, screen configuration information for displaying text, as shown in an example of FIG. 8A, may be added to a distribution package file for a Kubernetes application, such as a file of values.yaml of Helm.

Accordingly, the device 120 for distributing a Kubernetes application may analyze the distribution package file and configure and provide an option setup screen such as FIG. 8B to receive a user's input and, furthermore, can distribute the Kubernetes application by reflecting an option setting value (e.g., “A123” in FIG. 8B) input by the user as shown in FIG. 8C.

In addition, FIGS. 9A to 9C illustrate examples of a case of displaying a combo box in a distribution package file for a Kubernetes application.

In the present disclosure, screen configuration information for displaying a combo box, as shown in an example of FIG. 9A, may be added to a distribution package file for a Kubernetes application, such as a file of values.yaml of Helm.

Accordingly, the device 120 for distributing a Kubernetes application may analyze the distribution package file and configure and provide a combo box in an option setup screen such as FIG. 9B and, furthermore, can distribute the Kubernetes application by reflecting an option setting value (e.g., “a” in FIG. 9B) selected by the user in the combo box as shown in FIG. 9C.

Accordingly, in a method for distributing a Kubernetes application according to an embodiment of the present disclosure, when the version of a Kubernetes application is upgraded or a distribution option is changed, a change in distribution information, such as a release note of each Kubernetes application, may be automatically recognized and an option setup screen may be automatically configured and provided to a user, based on the recognition.

For example, an option setup screen may be configured and provided by using screen configuration information generated based on distribution option setup information including selection of Internal or External for PostgresSQL with respect to the example of application A v2.0 as described above.

More specifically, the device 120 for distributing a Kubernetes application may request a large language model (LLM), which is pretrained with the specification of screen configuration information of FIG. 7, to generate screen configuration information, based on distribution option setup information obtained from distribution information.

In this case, the device 120 for distributing a Kubernetes application may apply a large language model (LLM) so as to be able to respond to changes in various option values and effectively reduce the time taken to distribute a Kubernetes application, without a user knowing various rules for a dynamic Helm generation rule.

In a more specific example, with respect to the example of application A v2.0, the device 120 for distributing a Kubernetes application may add a text code, as shown in an example of FIG. 10A), from a large language model (LLM) to a distribution package file for a Kubernetes application, such as a file of values.yaml of Helm and, subsequently, dynamically configure and provide an option setup screen, based on screen configuration information obtained through analysis such as parsing of the distribution package file, as shown in FIG. 10B.

Accordingly, the device 120 for distributing a Kubernetes application can distribute the Kubernetes application after setting PostgresSQL to Internal by reflecting an option setting value (e.g., “Internal” in FIG. 10B) selected by a user in a combo box as shown in FIG. 10C.

In addition, a computer program according to another aspect of the present disclosure is a computer program stored in a computer-readable medium to execute, in a computer, a series of operations of a method for distributing a Kubernetes application described above. The computer program described above may include not only machine code generated by a compiler but also high-level language code that can be executed on a computer by using an interpreter, etc. In this context, the computer is not limited to personal computers (PCs) or notebook computers, but includes any information processing device equipped with a central processing unit (CPU) to be capable of executing a computer program, such as servers, smartphones, tablet PCs, PDAs, and mobile phones.

Furthermore, the computer-readable medium may either permanently store a computer-executable program or temporarily store same for execution or download. Moreover, the medium may be various recording means or storage means in the form of single hardware or a combination of multiple hardware, and is not limited to a medium directly connected to a computer system, but may be dispersed on a network. Accordingly, the above description should not be construed in a limiting sense in all respects but should be considered illustrative. The scope of the present disclosure should be determined by the reasonable interpretation of the appended claims, and all modifications within the equivalent scope of the present disclosure are included in the scope of the present disclosure.

In addition, the device 120 for distributing a Kubernetes application according to an embodiment of the present disclosure may include a processor and a memory, wherein the memory includes instructions that are configured to, when executed by the processor, cause the device to implement a particular operation, and the particular operation includes configuring a distribution package file by reflecting screen configuration information for distribution option setup, obtained based on distribution information on a Kubernetes application, providing an option setup screen for the Kubernetes application, configured based on the distribution package file, and distributing the Kubernetes application by reflecting an option setting collected through the option setup screen.

The device 120 for distributing a Kubernetes application according to an embodiment of the present disclosure may be easily implemented and carried out based on the method for distributing a Kubernetes application which has been described with reference to FIG. 1 to FIG. 10C. Hereinafter, therefore, the main elements of the present disclosure will be mainly described omitting repeated descriptions.

Here, in the configuring, distribution information on the Kubernetes application may be collected.

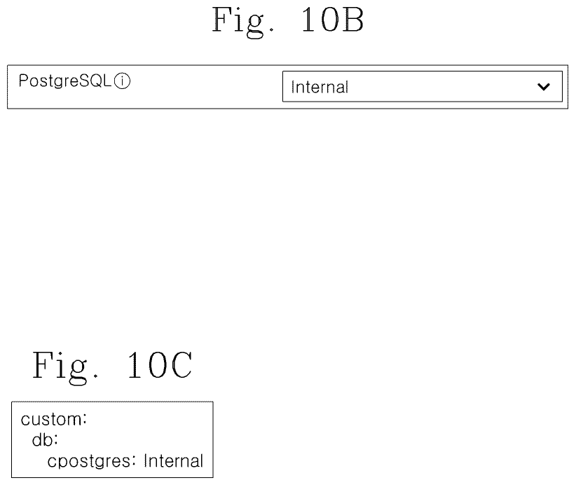

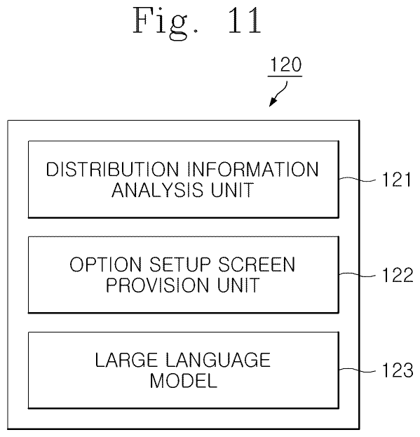

In addition, in the configuring, distribution option setup information regarding an option required to be set for the Kubernetes application may be obtained based on the distribution information by using a distribution information analysis unit 121 in FIG. 11.

In addition, in the configuring, screen configuration information for distribution option setup for the Kubernetes application may be generated based on the distribution option setup information.

In the generating, the screen configuration information may be generated using a large language model, based on the distribution option setup information.

Furthermore, in the configuring, the screen configuration information generated from a large language model 123 in FIG. 11 may be included in a distribution package file. In this case, FIG. 11 illustrates an example in which the large language model 123 is equipped in the device 120 for distributing a Kubernetes application. However, the present disclosure is not necessarily limited thereto, and may be implemented in various methods, such as generating screen configuration information by using an external large language model provided by a third party (3^{rd} party).

In addition, in the providing, as shown in FIG. 11, an option setup screen provision unit 122 operated in a computing device may collect the screen configuration information from the distribution package file to configure and provide the option setup screen.

In addition, in the distributing, a resource distributed for the Kubernetes application may be changed by reflecting the option setting.

In addition, FIG. 12 illustrates an example of the computing device 50 to which the proposed method of the present disclosure can be applied.

Referring to FIG. 12, the computing device 50 may be configured to implement a Kubernetes application distribution process according to the proposed method of the present disclosure.

For example, the computing device 50 to which the proposed method of the present disclosure can be applied may include a network device, such as a repeater, a hub, a bridge, a switch, a router, and a gateway, a computing device, such as a desktop computer and a workstation, a mobile terminals such as a smartphone, a portable device such as a laptop computer, an appliance such as a digital TV, and a transportation mean such as a car. As another example, the computing device 50 to which the present disclosure can be applied may be included as a part of an application specific integrated circuit (ASIC) implemented in the form of a system on chip (SoC).

A memory 20 may be connected to the processor 10 when operated, store programs and/or instructions for processing and controlling the processor 10, and store data and information used in the present disclosure, control information required for processing data and information according to the present disclosure, and temporary data occurring in a data and information processing process. The memory (20) may be implemented as a storage device such as read-only memory (ROM), random access memory (RAM), erasable programmable read-only memory (EPROM), electrically erasable programmable read-only memory (EEPROM), flash memory, static RAM (SRAM), hard disk drive (HDD), solid state drive (SSD), and the like.

The processor 10 may be connected to the memory 20 and/or a network interface 30 when operated (operatively) and control an operation of each module in the computing device 50. Specifically, the processor 10 may perform various control functions for performing the proposed method of the present disclosure. The processor 10 may be called a controller, a microcontroller, a microprocessor, a microcomputer, etc. The proposed method of the present disclosure may be implemented by hardware or firmware, software, or a combination thereof. When the present disclosure is implemented using hardware, an application-specific integrated circuit (ASIC) or a digital signal processor (DSP), a digital signal processing device (DSPD), a programmable logic device (PLD), and a field-programmable gate array (FPGA) configured to perform the present disclosure may be included in the processor 10. Meanwhile, when implementing the proposed method of the present disclosure by using firmware or software, the firmware or software may include instructions related to modules, procedures, or functions that perform the functions or operations required to implement the proposed method of the present disclosure. The instructions are stored in the memory 20 or in a computer-readable recording medium (not shown) separate from the memory 20, and may be configured to, when executed by the processor 10, cause the device 50 to implement the proposed method of the present disclosure.

In addition, the computing device 50 may include a network interface device 30. The network interface device 30 is connected to the processor 10 when operated, and the processor 10 may control the network interface device 30 to transmit or receive a wireless/wired signal carrying information and/or data, a signal, a message, etc. through a wireless/wired network. The network interface device 30 supports various communication specifications, such as IEEE 802 series, 3GPP LTE(-A), 3GPP 5G, etc., and may transmit and receive control information and/or a data signal according to a corresponding communication specification. The network interface device 30 may also be implemented outside the computing device 50 if necessary.

Accordingly, in a method, a device, a system, and a computer program for distributing a Kubernetes application according to an embodiment of the present disclosure, a user can conveniently set an option for distribution of a Kubernetes application and, furthermore, efficiently distribute the Kubernetes application according to the set option, and in addition, an environment in which a Kubernetes application is distributable by reflecting the addition, change, etc. of configurable options with respect to various Kubernetes applications can be automatically configured and provided.

The above embodiments and drawings described in this specification are merely illustrative and do not in any way limit the scope of the present disclosure. Furthermore, the connections or lack of connections between the elements shown in the drawings are intended to represent functional and/or physical or circuit connections illustratively, and in actual devices, may be represented by various alternative or additional functional, physical, or circuit connections. Additionally, unless explicitly stated as “essential” or “critical”, the elements may not be strictly necessary for the application of the present disclosure.

The use of the term “the” and similar referents in the specification (especially in the following claims) of the present disclosure may be construed to cover both the singular and the plural. Furthermore, recitation of ranges provided in the present disclosure is intended to serve the invention to which individual values falling within the range are applied (unless otherwise indicated herein), and each individual value included in the range is incorporated into the detailed description as if it were recited herein. The operations presented in the method invention of the present disclosure are not necessarily intended to be limited by the order. Unless the nature of each process requires that one operation precede another, the order may be appropriately modified as needed. Furthermore, all examples or illustrative terms (“for example” and “etc.”) used in the present disclosure are merely for the sake of providing a detailed description of the present disclosure. The above examples or illustrative terms does not limit the scope of the present disclosure unless otherwise restricted by the claims. Also, a person skilled in the art would understood that the present disclosure may be configured according to design conditions and factors within the scope of the claims or their equivalents to which various modifications, combinations, and changes are added.

What is claimed is:

1. A method for distributing a Kubernetes application by using a computing device, the method comprising:
configuring a distribution package file by reflecting screen configuration information for distribution option setup, obtained based on distribution information on a Kubernetes application;
providing an option setup screen for the Kubernetes application, configured based on the distribution package file; and
distributing the Kubernetes application by reflecting an option setting collected through the option setup screen.

2. The method of claim 1, wherein the configuring comprises collecting the distribution information on the Kubernetes application.

3. The method of claim 1, wherein the configuring comprises obtaining distribution option setup information regarding an option required to be set for the Kubernetes application, based on the distribution information.

4. The method of claim 1, wherein the configuring comprises generating screen configuration information for distribution option setup for the Kubernetes application, based on distribution option setup information.

5. The method of claim 4, wherein, in the generating, the screen configuration information is generated using a large language model, based on the distribution option setup information.

6. The method of claim 5, wherein, in the configuring, the screen configuration information generated from the large language model is included in the distribution package file.

7. The method of claim 1, wherein, in the providing, an option setup screen provision unit operated in the computing device collects the screen configuration information from the distribution package file to configure and provide the option setup screen.

8. The method of claim 1, wherein, in the distributing, a resource distributed for the Kubernetes application is changed by reflecting the option setting.

9. A device for distributing a Kubernetes application, the device comprising:
a processor; and
a memory,
wherein the memory comprises instructions that are configured to, when executed by the processor, cause the device to implement particular operations, and the particular operations comprises:
configuring a distribution package file by reflecting screen configuration information for distribution option setup, obtained based on distribution information on a Kubernetes application;
providing an option setup screen for the Kubernetes application, configured based on the distribution package file; and
distributing the Kubernetes application by reflecting an option setting collected through the option setup screen.

10. The device of claim 9, wherein, in the configuring, the distribution information on the Kubernetes application is collected.

11. The device of claim 9, wherein, in the configuring, distribution option setup information regarding an option required to be set for the Kubernetes application is obtained based on the distribution information.

12. The device of claim 11, wherein, in the configuring, screen configuration information for distribution option setup for the Kubernetes application is generated based on the distribution option setup information.

13. The device of claim 12, wherein, in the generating, the screen configuration information is generated using a large language model, based on the distribution option setup information.

14. The device of claim 13, wherein, in the configuring, the screen configuration information generated from the large language model is included in the distribution package file.

15. The device of claim 9, wherein, in the providing, an option setup screen provision unit operated in a computing device collects the screen configuration information from the distribution package file to configure and provide the option setup screen.

16. The device of claim 9, wherein, in the distributing, a resource distributed for the Kubernetes application is changed by reflecting the option setting.

17. A non-transitory computer-readable storage medium storing instructions configured to, when executed by a processor, cause a device, comprising the processor, for distributing a Kubernetes application to implement particular operations, the particular operations comprising:
configuring a distribution package file by reflecting screen configuration information for distribution option setup, obtained based on distribution information on a Kubernetes application;
providing an option setup screen for the Kubernetes application, configured based on the distribution package file; and
distributing the Kubernetes application by reflecting an option setting collected through the option setup screen.

18. The non-transitory computer-readable storage medium of claim 17, wherein, in the configuring, the distribution information on the Kubernetes application is collected.

19. The non-transitory computer-readable storage medium of claim 17, wherein, in the configuring, distribution option setup information regarding an option required to be set for the Kubernetes application is obtained based on the distribution information.

20. The non-transitory computer-readable storage medium of claim 19, wherein, in the configuring, screen configuration information for distribution option setup for the Kubernetes application is generated based on the distribution option setup information.
